(19) United States
(12) Patent Application Publication
(10) Pub. No.: US 2026/0198470 A1
(43) Pub. Date: Jul. 16, 2026

(54) Tip-Up Sound-Emitting Device

(71) Applicant: Lloyd Later, Webster, NY (US)

(72) Inventor: Lloyd Later, Webster, NY (US)

(21) Appl. No.: 19/399,867

(22) Filed: Nov. 25, 2025

Related U.S. Application Data
(60) Provisional application No. 63/745,864, filed on Jan. 16, 2025.

(51) Int. Cl. A01K 97/01

(52) U.S. Cl. CPC A01K 97/01

(57) ABSTRACT

A tip-up sound-emitting device is provided. The device is comprised of a tip-up sound-emitting device configured for integration with conventional ice fishing tip-up systems, wherein the device comprises a spring-biased hammer assembly operatively connected to a sound-producing element, wherein the hammer is maintained under tension by a trigger assembly. The hammer rotates about a pivot point and impacts against a sound-producing element. The trigger is actuated by a pull string that connects to the tip-up flag and/or trip mechanism. Upon a fish strike, the flag rises and/or mechanism engages, which transmits force through the pull string to disengage the trigger, releasing the hammer to strike the resonating element and emit an audible alert.

### CROSS-REFERENCE TO RELATED APPLICATION

The present application claims priority to, and the benefit of, U.S. Provisional Application No. 63/745,864, which was filed on Jan. 16, 2025, and is incorporated herein by reference in its entirety.

### FIELD OF THE INVENTION

The present invention relates generally to the field of ice fishing. More specifically, the present invention relates to a sound-emitting attachment for ice fishing tip-up systems. Upon a fish strike, a pull string linked to the tip-up flag or trip mechanism actuates a trigger, releasing a hammer to rotate and strike a resonating element, thereby producing an audible alert. Accordingly, the present disclosure makes specific reference thereto. Nonetheless, it is to be appreciated that aspects of the present invention are also equally applicable to other like applications, devices, and methods of manufacture.

### BACKGROUND

A tip-up is a mechanical fishing device used in ice fishing to signal when a fish strikes bait suspended through a hole in the ice. Traditional tip-ups are comprised of a frame that rests on the ice surface, a spool of line that extends into the water, and a spring-loaded flag that is triggered when a fish takes the bait and pulls the line. Once the flag is released and becomes upright, it visually indicates to the angler that a fish is on the line. Ice anglers often deploy multiple tip-ups, sometimes up to five, across a wide frozen area up to one-half acre, allowing them to cover more water and increase the probability of catching fish. This method, however, requires constant visual monitoring of each tip-up flag in order to respond promptly to a strike. This becomes increasingly difficult when the angler is engaged in other tasks, such as jigging with a separate rod or operating in low-visibility conditions such as fog, snowfall, or nighttime hours. A delayed response to a raised flag can result in the fish escaping, the reel being fully spooled, or physical injury to a fish intended for release. Additionally, anglers with limited mobility or visual acuity are further disadvantaged by the flag-only notification system. Current tip-up systems do not provide a means for audio-based detection, making fish monitoring an inefficient and error-prone process. These operational shortcomings indicate a need for an improved system capable of augmenting or replacing visual cues with reliable auditory signals.

Therefore, there exists a long-felt need in the art for a tip-up sound-emitting device that provides an immediate auditory signal in response to a fish strike. There also exists a long-felt need in the art for a tip-up sound-emitting device that reduces the requirement for constant visual monitoring of multiple tip-ups. Moreover, there exists a long-felt need in the art for a tip-up sound-emitting device that facilitates fish strike detection under nighttime or low-visibility conditions.

The subject matter disclosed and claimed herein, in one embodiment thereof, comprises a tip-up sound-emitting device. The device is comprised of a tip-up sound-emitting device configured for integration with conventional ice fishing tip-up systems, wherein the device comprises a spring-biased hammer assembly operatively connected to a sound-producing element, wherein the hammer is maintained under tension by a trigger assembly. The hammer rotates about a pivot point and impacts against a sound-producing element. The trigger is actuated by a pull string which connects to the tip-up flag and/or trip mechanism. Upon a fish strike, the flag rises and/or the mechanism engages, which transmits force through the pull string to disengage the trigger, releasing the hammer to strike the resonating element and emit an audible alert.

In this manner, the tip-up sound-emitting device of the present invention accomplishes all the foregoing objectives and provides an audible alert triggered by fish activity, thereby enabling real-time monitoring of tip-ups without requiring the angler to maintain constant visual contact with multiple tip-ups. The spring-loaded hammer and resonating chamber configuration further generates a distinct sound that can be detected across distances and under adverse visibility conditions, addressing the limitations of traditional flag-only systems. As a result, the device enhances strike detection, reduces lost fish incidents, and significantly improves the overall efficiency and accessibility of ice fishing operations.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tip-up sound-emitting device. The device is designed for integration with ice fishing tip-up systems to emit an audible signal in response to activation caused by a fish strike, enabling audio-based remote monitoring and reducing the need for continuous visual observation.

The device is comprised of at least one spring, operatively connected to at least one hammer. The spring may be of various types and stores mechanical energy. The hammer is configured to rotate about a pivot point and may include a rubberized grip to enhance impact control and energy transfer to a sound-producing element. The sound-producing element is comprised of a hollow metallic resonating chamber of various shapes and acoustic materials, designed to emit a distinctive and loud signal. The hammer is held under load by a trigger assembly comprised of mechanical or magnetic release mechanisms, which maintains the hammer in a cocked position until actuated.

Actuation of the hammer is performed via a pull string comprised of abrasion-resistant materials. The pull string is connected to the tip-up flag or trip mechanism using a connection assembly and features adjustable fasteners to control activation distance. Upon a fish strike, movement of the tip-up flag or mechanism applies tension to the pull string, releasing the hammer from the trigger. The hammer then rotates under spring force and impacts the sound-producing element, generating an audible signal detectable by the angler.

A method of use involves securing the device to a tip-up system, cocking the hammer, connecting the pull string to the flag or trip mechanism, and upon a fish strike, enabling the hammer to impact the sound-producing element, and observing the audible alert to alert an angler to a catch.

Accordingly, the tip-up sound-emitting device of the present invention is particularly advantageous as it provides an audible alert triggered by fish activity, thereby enabling real-time monitoring of tip-ups without requiring the angler to maintain constant visual contact with multiple tip-ups. The spring-loaded hammer and resonating chamber configuration further generates a distinct sound that can be detected across distances and under adverse visibility conditions, addressing the limitations of traditional flag-only systems. As a result, the device enhances strike detection, reduces lost fish incidents, and significantly improves the overall efficiency and accessibility of ice fishing operations. In this manner, the tip-up sound-emitting device overcomes the limitations of existing tip-ups and methods of use known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a tip-up sound-emitting device of the present invention in accordance with the disclosed architecture;

FIG. 2 illustrates a flowchart of a method of using one potential embodiment of a tip-up sound-emitting device of the present invention in accordance with the disclosed architecture; and

FIG. 3 illustrates a perspective view of one potential embodiment of a tip-up sound-emitting device of the present invention while attached to a tip-up via a fastener in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a tip-up sound-emitting device that provides an immediate auditory signal in response to a fish strike. There also exists a long-felt need in the art for a tip-up sound-emitting device that reduces the requirement for constant visual monitoring of multiple tip-ups. Moreover, there exists a long-felt need in the art for a tip-up sound-emitting device that facilitates fish strike detection under nighttime or low-visibility conditions.

The present invention, in one exemplary embodiment, is comprised of a tip-up sound-emitting device. The device is designed for integration with existing ice fishing tip-up systems to allow for an audible signal to be generated when a fish strike activates the system. This configuration supports audio-based remote monitoring, minimizing the requirement for continuous visual checks across multiple fishing lines.

The device has a spring mechanically linked to a hammer. The spring, which may take various forms, functions to store mechanical energy. The hammer is capable of rotating about a pivot point and may be fitted with a rubberized grip to improve energy transfer and impact control with a sound-producing element. The element includes a hollow metallic resonating chamber, fabricated from acoustic materials in various shapes, and designed to produce a distinct and loud audible signal. A trigger assembly, utilizing mechanical or magnetic mechanisms, holds the hammer in a cocked position until activated.

The hammer is activated through a pull string manufactured from abrasion-resistant materials. The pull string connects to the tip-up flag or trip mechanism through a connection assembly and includes adjustable fasteners to regulate activation distance. When a fish strike occurs, movement of the tip-up flag or mechanism applies tension to the pull string, which disengages the hammer from the trigger. The hammer then rotates under the stored energy of the string and strikes the sound-producing element, producing an audible signal perceptible to the angler.

A method of operation involves attaching the device to a tip-up system, positioning the hammer in a cocked state, linking the pull string to the flag or trip mechanism, and allowing the hammer to strike the sound-producing element upon a fish strike. The resulting audible alert informs the angler of a catch.

As a result, the tip-up sound-emitting device delivers a significant advantage by enabling real-time fish strike detection through an audible alert. The combination of a spring-loaded hammer and resonating chamber yields a unique sound capable of being heard at extended distances and in poor visibility, thereby resolving the limitations associated with conventional flag-only detection systems. The device further enhances strike recognition, reduces missed catches, and increases both efficiency and accessibility in ice fishing, effectively addressing known shortcomings in existing tip-up devices and methods.

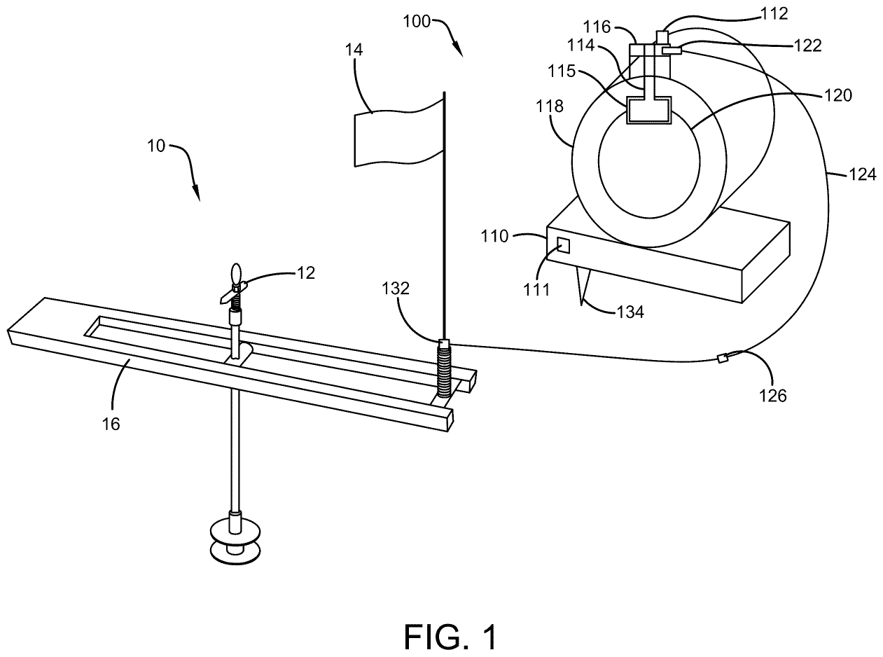

Referring initially to the drawings, FIG. 1 illustrates a perspective view of one potential embodiment of a tip-up sound-emitting device 100 of the present invention in accordance with the disclosed architecture. The device 100 is designed for integration with existing ice fishing tip-up systems 10. More specifically, the device 100 is primarily configured to emit an audible signal in response to a tip-up activation of the system 10 caused by a fish strike, thereby facilitating audio-based remote monitoring and minimizing the need for continuous visual observation across multiple fishing lines.

The device 100 may be comprised of a base 110. The base 110 may be fabricated from durable, low-temperature-resistant materials such as high-density polyethylene, anodized aluminum, polyoxymethylene (POM), or fiber-reinforced composite polymers. The base 110 may serve as a mounting and support structure for all subsequent components and may include fasteners 111, such as, but not limited to, clips, spring-loaded clamps, magnetic pads, or suction cups for secure connection to the tip-up frame 16.

The device 100 may also be comprised of at least one spring 112, a seen in FIG. 1. The spring 112 may be a torsion spring configured to store mechanical potential energy when biased. In alternate configurations, the spring 112 may be a tension spring, helical compression spring, or cantilever leaf spring. The spring 112 may be operatively connected to at least one hammer 114. The hammer 114 may be comprised of stainless steel, hardened aluminum alloy, high-impact polycarbonate, or layered composite materials. The hammer 114 may be configured to rotate about at least one pivot point 116. The pivot point 116 may be comprised of, but is not limited to, a pin, an axle, a rotary shaft, etc. In one embodiment, the hammer 114 may further comprise a rubberized grip 115. The grip 115 may be fabricated from thermoplastic elastomer, silicone, nitrile rubber, or EPDM compounds to enhance impact control and optimize energy transfer to the adjacent sound-producing element 118.

The sound-producing element 118 may be comprised of a hollow, metallic resonating chamber 120. The chamber 120 may be any shape such as, but not limited to, dome-shaped, bell-shaped, cylindrical, or conical, and may be comprised of acoustic-grade brass, stainless steel, aluminum, or sound-optimized polymer alloys. The wall thickness, curvature, alloy composition, and surface finish of the chamber 120 may be varied to produce distinctive and highly audible acoustic signatures under windy or low-visibility conditions. In alternate configurations, the sound-producing element 118 may be a suspended chime bar, a concave gong plate, etc.

The hammer 114 may be retained under load by a trigger assembly 122, as seen in FIG. 1. The trigger assembly 122 may be comprised of, but is not limited to, a mechanical latch, sear-type release, gravity-biased detent, or magnetic catch mechanism. The trigger 122 may further maintain the hammer 114 in a cocked position until disengaged.

The trigger 122 may be actuated by a pull string or cord 124, as seen in FIG. 1. The pull string 124 may be comprised of water-repellent and abrasion-resistant materials such as, but not limited to, coated stainless steel wire. The pull string 124 may be operatively coupled to the tip-up flag 14 and/or trip mechanism 12 of a tip-up system 10 via at least one connection assembly 132. The connection assembly 132 may be comprised of components such as, but not limited to, stainless snap hooks, spring clips, key rings, swiveling eyelets, looped shackles, crimped cable terminals, etc. The length of the pull string 124 may be adjustable via at least one fastener 126. The fastener 126 may be comprised of, but not limited to, a toothed cam cleat, spring-loaded cord lock, sliding friction clamp, or twist-lock ferrule to facilitate micro-adjustment of the activation travel distance.

Upon a fish strike, the tip-up flag 14 is raised and/or the mechanism 12 is engaged. This movement transmits tensile force through the pull string 124 to the trigger 122. The applied force disengages the trigger 122 from the hammer 114, allowing the stored energy in the spring 112 to rotate the hammer 114. The hammer 114 then impacts the sound-producing element 118, such as the resonating chamber 120, generating a loud, distinctive audible signal detectable at extended distances by the angler.

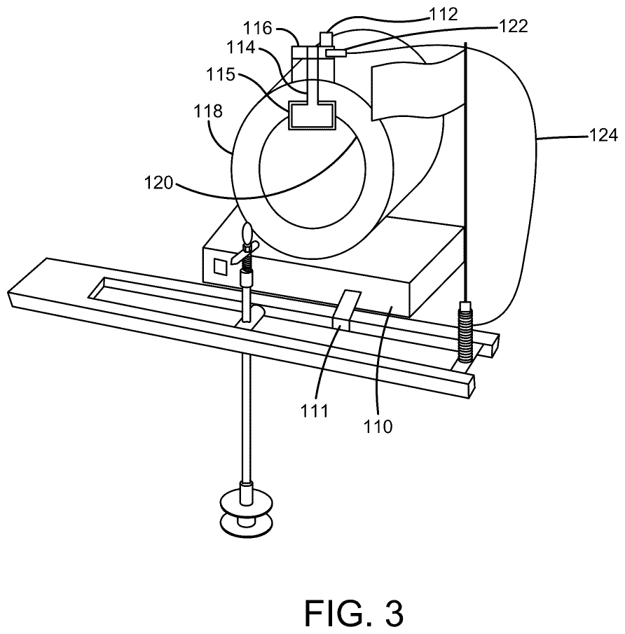

To ensure stable deployment in a range of conditions, the base 110 may further comprise at least one mounting structure 134. The mounting structure 134 may be configured for secure attachment to either the ice surface or the frame of the tip-up assembly 10. The mounting structure 134 may be comprised of anchoring mechanisms such as but not limited to threaded ice screws, deployable stakes, suction pads, or adjustable legs, etc. In one embodiment, the base 110 is comprised of a fastener 111, such as but not limited to a clip, a clamp, a magnet, etc., that allows the base 110 to attach to the frame 116, as seen in FIG. 3. In another embodiment, the fastener 111 may be located elsewhere on the device 100, such as the element 118.

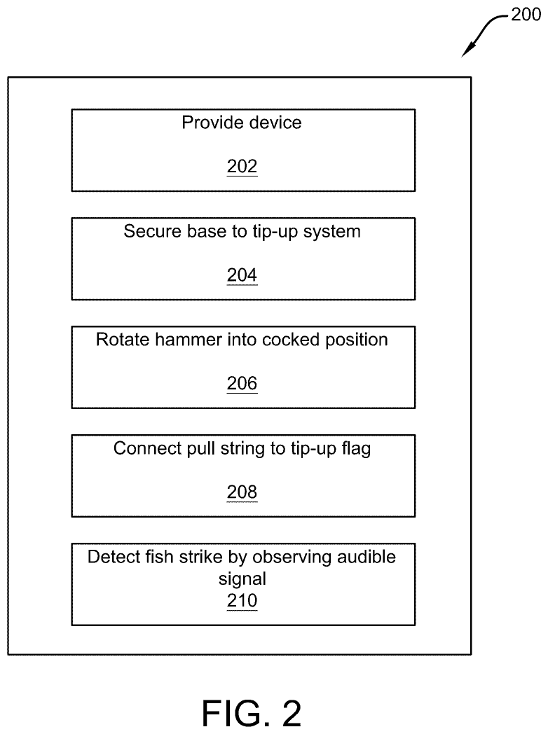

The present invention is also comprised of a method of using 200 the device 100, as seen in FIG. 2. First, a device 100 is provided comprised of a base 110, at least one spring 112, at least one hammer 114 with a grip 115, at least one pivot point 116, at least one sound-producing element 118, a trigger assembly 122, a pull string 124, a connection assembly 132, and a mounting structure 134 [Step 202]. Then, the base 110 is secured to a tip-up system 10 via the fasteners 111 and/or secured in the ice near the system 10 via the fasteners 134 [Step 204]. Next, the hammer 114 can be rotated into a cocked position and retained under load by the trigger assembly 122 while the spring 112 stores mechanical energy [Step 206]. Then, the pull string 124 is connected to the tip-up flag 14 and/or the trip mechanism 12 using the connection assembly 132 [Step 208]. Upon a fish strike, the tip-up mechanism 12 engages, or the flag 14 raises, applying tensile force through the pull string 124 to actuate the trigger 122 and release the hammer 114. The released hammer 114 then rotates about the pivot point 116 under spring force and strikes the sound-producing element 118, generating a loud audible signal. Then an angler can detect a fish strike on the system 10, and ascertain the location of the system 10, by observing the audible signal [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tip-up sound-emitting device” and “device” are interchangeable and refer to the tip-up sound-emitting device 100 of the present invention.

Notwithstanding the foregoing, the tip-up sound-emitting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the tip-up sound-emitting device 100 as shown in the FIGS. are for illustrative purposes only, and that many other sizes and shapes of the tip-up sound-emitting device 100 are well within the scope of the present disclosure. Although the dimensions of the tip-up sound-emitting device 100 are important design parameters for user convenience, the tip-up sound-emitting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tip-up sound-emitting device comprising:
a base;
a spring;
a hammer operatively connected to the spring and configured to rotate about a pivot point;
a sound-producing element positioned to be impacted by the hammer;
a trigger assembly configured to retain the hammer in a cocked position under load from the spring; and
a pull string.

2. The tip-up sound-emitting device of claim 1, wherein the base is comprised of a fastener.

3. The tip-up sound-emitting device of claim 1, wherein the spring is comprised of a torsion spring, a tension spring, a helical compression spring, and a cantilever leaf spring.

4. The tip-up sound-emitting device of claim 1, wherein the hammer is comprised of a grip.

5. The tip-up sound-emitting device of claim 1, wherein the sound-producing element is comprised of a hollow resonating chamber.

6. The tip-up sound-emitting device of claim 1, wherein the sound-producing element is comprised of a suspended chime bar.

7. The tip-up sound-emitting device of claim 1, wherein the sound-producing element is comprised of a concave gong plate.

8. The tip-up sound-emitting device of claim 1, wherein the trigger assembly is comprised of a mechanical latch, a sear-type release, a gravity-biased detent, or a magnetic catch mechanism.

9. A tip-up sound-emitting device comprising:
a base;
a spring;
a hammer operatively connected to the spring and configured to rotate about a pivot point;
a sound-producing element positioned to be impacted by the hammer;
a trigger assembly configured to retain the hammer in a cocked position under load from the spring;
a pull string; and
a connection assembly for connecting the pull string to a tip-up system.

10. The tip-up sound-emitting device of claim 9, wherein the base is comprised of a fastener.

11. The tip-up sound-emitting device of claim 9, wherein the spring is comprised of a torsion spring, a tension spring, a helical compression spring, and a cantilever leaf spring.

12. The tip-up sound-emitting device of claim 9, wherein the hammer is comprised of a grip.

13. The tip-up sound-emitting device of claim 9, wherein the sound-producing element is comprised of a hollow resonating chamber.

14. The tip-up sound-emitting device of claim 9, wherein the sound-producing element is comprised of a suspended chime bar.

15. The tip-up sound-emitting device of claim 9, wherein the sound-producing element is comprised of a concave gong plate.

16. The tip-up sound-emitting device of claim 9, wherein the trigger assembly is comprised of a mechanical latch, a sear-type release, a gravity-biased detent, or a magnetic catch mechanism.

17. The tip-up sound-emitting device of claim 9, wherein the pull string is comprised of a second fastener that allows a length of the pull string to adjust.

18. The tip-up sound-emitting device of claim 17, wherein the second fastener is comprised of a toothed cam cleat, a spring-loaded cord lock, a sliding friction clamp, or a twist-lock ferrule.

19. The tip-up sound-emitting device of claim 9, wherein the connection assembly is comprised of a snap hook, a spring clip, a key ring, a swiveling eyelet, a looped shackle, or a crimped cable terminal.

20. A method of using a tip-up sound-emitting device, the method comprising the following steps:
providing a tip-up sound-emitting device comprised of a base, a spring, a hammer, a pivot point, a sound-producing element, a trigger assembly, and a pull string;
securing the base to a tip-up system or an ice surface;
cocking the hammer and retaining the hammer under load via the trigger assembly;
connecting the pull string to a flag or a trip mechanism of the tip-up system using a connection assembly; and
observing an audible signal from the hammer striking the sound-producing element to indicate a fish strike on the tip-up system.
